(19) United States
(12) Patent Application Publication
(10) Pub. No.: US 2025/0217659 A1
(43) Pub. Date: Jul. 3, 2025

(54) A DEVICE AND A COMPUTER-IMPLEMENTED METHOD FOR CONTINUOUS-TIME INTERACTION MODELING OF AGENTS

(71) Applicant: Robert Bosch GmbH, Stuttgart (DE)

(72) Inventors: Barbara Rakitsch, Stuttgart (DE); Cagatay Yildiz, Tübingen (DE)

(21) Appl. No.: 18/850,443

(22) PCT Filed: May 2, 2023
(86) PCT No.: PCT/EP2023/061551

§ 371 Date: Sep. 24, 2024

(30) Foreign Application Priority Data
May 13, 2022 (DE) 10 2022 204 711.7

(51) Int. Cl. G06N 3/092; G06F 17/18

(52) U.S. Cl. CPC G06N 3/092; G06F 17/18

(57) ABSTRACT

A device and computer-implemented method for continuous-time interaction modeling of agents. The method includes: providing latent states of first and second agents, respectively; providing a first Gaussian process distribution for a first function for modelling a kinematic behavior of an agent independently of other agents and a second Gaussian process distribution for a second function for modelling an interaction between agents; sampling the first function from the first Gaussian process distribution and the second function from the second Gaussian process distribution, the first function mapping a latent state of one agent to a contribution to a change of its latent state, the second function mapping the latent states of two agents to a contribution to a change of a latent state of one of the two agents; changing the latent state of the first agent.

### FIELD

The present invention relates to a device and a computer-implemented method for continuous-time interaction modeling of agents, in particular subjects of objects.

### BACKGROUND INFORMATION

Learning the behavior of unknown dynamical systems from data is a fundamental problem in machine learning.

### SUMMARY

Ae computer-implemented method and device according to the present invention use a model that is based on Gaussian processes, GPS, and operates in continuous-time and decomposes complex continuous dynamics into independent kinematics and interaction components to account for interpretable non-linear dynamics. This model treats the independent kinematics of the agents and their interactions separately. The function-level regularization via GPs is key to learn disentangled representations. The model is based on an ordinary differential equation, ODE. This accounts for many complex dynamics that have a natural representation in terms of time differentials. The continuous-time formulation allows straightforward integration of domain knowledge leveraging the inductive bias of the model. Thus, the kinematics of objects and their interactions are modelled separately with two distinct Gaussian processes.

According to an example embodiment of the present invention, the computer-implemented method for continuous-time interaction modeling of agents comprises providing a latent state of a first agent and a latent state of a second agent, in particular characterizing a position or a velocity of these agents, providing a first Gaussian process distribution for a first function for modelling a kinematic behavior of an agent independently of other agents and a second Gaussian process distribution for a second function for modelling an interaction between agents, sampling the first function from the first Gaussian process distribution and the second function from the second Gaussian process distribution, wherein the first function is configured to map a latent state of one agent to a contribution to a change of its latent state, wherein the second function is configured to map the latent states of two agents to a contribution to a change of a latent state of one of the two agents, wherein the method comprises changing the latent state of the first agent depending on a first contribution that results from mapping of the latent state of the first agent with the first function to the first contribution and second contribution that results from a mapping of the latent state of the first agent and the latent state of the second agent with the second function to the second contribution.

According to an example embodiment of the present invention, the method preferably comprises providing an initial latent state of a plurality of agents including the first agent and the second agent and either changing the latent state of the first agent depending on the second contributions that result from mapping pairs of the latent state of the first agent and different second agents of the plurality of agents with the second function, or selecting a subset of the plurality of agents, changing the latent state of the first agent depending on the second contributions that result from mapping pairs of the latent state of the first agent and different second agents of the subset with the second function. Thus, the method considers either all agents that are different from the first agent or a neighborhood of the agent for the interactions. Agents that are not in the neighborhood of an agent are less likely to interact with the agent. This reduces the computational load while maintaining a reasonable precision of the model.

According to an example embodiment of the present invention, the method preferably comprises determining agents from the plurality of agents for the subset that are, according to a measure for a distance between agents, closer to the first agent than other agents of the plurality of agents. Thus, the method considers a neighborhood of the agent for the interactions. The metric may be a measure for any sort of property of agents. For movements of agents, their distance to each other is a preferred metric.

According to an example embodiment of the present invention, the method preferably comprises providing a data sequence, wherein providing the initial latent state of the first agent and/or the second agent comprises determining its initial latent state with an encoder that is configured to map the data sequence to its initial latent state.

According to an example embodiment of the present invention, the method preferably comprises determining an output depending on the latent state of the first agent, in particular a trajectory sample preferably a trajectory of a position and/or velocity of the first agent over time. The output can relate to any sort of property of the agents. For movants of agents, trajectory samples are a preferred output.

Preferably, the first Gaussian process distribution comprises a posterior, wherein the method comprises learning an in particular sparse approximation to the posterior for the first Gaussian process distribution that entails variational parameters, and providing the approximation for the first Gaussian process distribution as the first Gaussian process distribution, and/or wherein the second Gaussian process distribution comprises a posterior, wherein the method comprises learning an in particular sparse approximation to the posterior for the second Gaussian process distribution that entails variational parameters, and providing the approximation for the second Gaussian process distribution as the second Gaussian process distribution. This way, the parameters that define the Gaussian process distribution are learned for unknown functions.

According to an example embodiment of the present invention, the method preferably comprises determining the first Gaussian process distribution or the second Gaussian process distribution with an expected likelihood term that depends on the output and that decomposes between agents and between time points. The likelihood term is an approximation of a part of an evidence lower bound, ELBO that allows to determine the parameters that define the Gaussian process distribution.

The method may be applied to second order ordinary differential equations, wherein the latent state of the first agent comprises a first component and a second component, wherein the method comprises changing the latent state of the first component of the latent state of the first agent depending on the second component of the latent state of the first agent and a change to the second component of the latent state of the first agent, wherein the second component is changed depending on the first contribution to the change of the latent state of the first agent and the second contribution to the change of the latent state of the first agent.

To control the first agent, the method may comprise determining an action for the first agent depending on the output.

The method preferably comprises determining the latent state of the first agent and the latent state of the second agent depending on a measurement of an sequence of observable states of the agents.

The first agent may be an existing object in the physical world, wherein the latent state of the first agent is determined depending on a measurement of a property of the first agent, and/or wherein the second agent may be an existing object in the physical world, wherein the latent state of the second agent is determined depending on a measurement of a property of the second agent, in particular wherein the measurement comprises position data, in particular from a satellite navigation system, or in particular digital images, preferably video images, radar images, LiDAR images, ultrasonic images, motion images and/or thermal images, preferably from information about a position or a velocity of the agents. This allows determining the latent states from measurement and in particular an according control of the first agent.

According to the present invention, the device for continuous-time interaction modeling of agents comprises at least one processor and at least one memory that are configured to execute steps in the method of the present invention. This device has advantages that correspond to the advantages of the method.

According to an example embodiment of the present invention, the device preferably comprises an interface that is adapted to observe a continuous-time interaction of the agents, in particular digital images, preferably video images, radar images, LiDAR images, ultrasonic images, motion images and/or thermal images, or to receive information about a continuous-time interaction of the agents.

The interface may be adapted to control an action of at least one of the agents depending on the output or the action.

A computer program that comprises computer readable instructions that when executed by a computer cause the computer to execute the method of the present invention provides advantages that correspond to the advantages of the method of the present invention.

Further advantageous embodiments of the present invention are derived from the following description and the figures.

### BRIEF DESCRIPTION OF THE DRAWINGS

FIG. 1 schematically depicts a device for continuous-time interaction modeling of agents, according to an example embodiment of the present invention.

FIG. 2 depicts steps in a method of continuous-time interaction modeling of agents, according to an example embodiment of the present invention.

### DETAILED DESCRIPTION OF EXAMPLE EMBODIMENTS

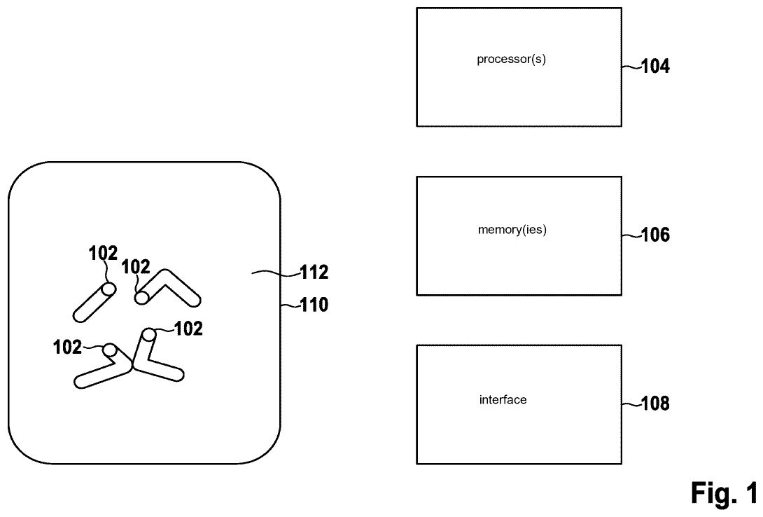

FIG. 1 depicts a device 100 for continuous-time interaction modeling of agents 102. In FIG. 1, four agents 102 are depicted. There may be more or less than four agents 102.

The device 100 comprises at least one processor 104 and at least one memory 106. The device 100 may comprise an interface 108.

The at least one processor 104 is adapted to executes steps of a method that is described below. The at least one memory 106 is adapted to store instructions, in particular a computer program, that when executed by the at least one processor 104, cause the processor 104 to execute the steps of the method.

The interface 108 is in one example adapted to observe a continuous-time interaction of the agents 102 or to receive information about a continuous-time interaction of the agents 102. The interface 108 is in one example adapted to control an action of at least one of the agents 102.

The information is for example provided in digital images, e.g. video images, radar images, LiDAR images, ultrasonic images, motion images and/or thermal images.

The continuous-time interaction of the agents 102 comprises for example a position or a velocity of the agents 102. The position may be a relative position, e.g. a distance between pairs of agents 102, or an absolute position of agents 102.

In the example, a system 110 comprises the agents 102. The system 110 may be a physical system. The agents 102 may be physical systems, in particular technical systems. The agents 102 may be existing real objects in the physical world. The agents 102 may comprise vehicles, pedestrians or other moving objects, such as balls.

The system 110 comprises an environment 112. The environment 112 may comprise a road infrastructure or building infrastructure. The agents 102 in the example move in the environment 112 and may be affected by the environment 112. The agents 102 may comprise objects of the environment 112, e.g. stationary infrastructure systems that are part of the environment 112. The system 110 in the example follows certain physical rules. A physical rule is for example that an integral of a velocity is a position.

The continuous-time interaction is not limited to these physical quantities. The continuous-time interaction may comprise other physical quantities, technical quantities, or chemical quantities. The continuous-time interaction may involve global latent variables, e.g., agent-specific properties such as mass or radius as well.

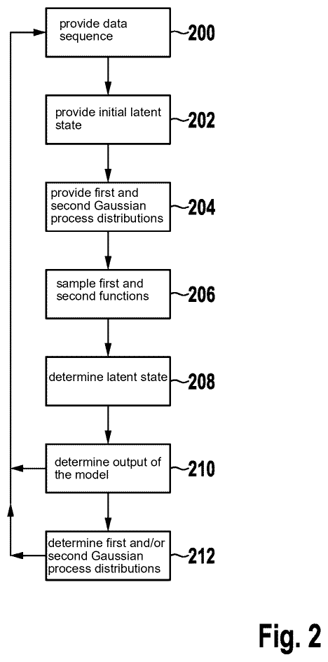

FIG. 2 depicts steps in the method for continuous-time interaction modeling of agents.

The method depends on a model:

$${h}_{1}^{a} ∼ N ( 0 , I )$$

$${f}_{s} ( \cdot ) ∼ GP ( 0 , {k}_{s} ( \cdot , \cdot ) )$$

$${f}_{b} ( \cdot ) ∼ GP ( 0 , {k}_{b} ( \cdot , \cdot ) )$$

$${h}^{a} = {h}_{1}^{a} + {\int }_{{t}_{1}}^{{t}_{n}} {f}_{s} ( {h}^{a} ( τ ) ) + {\sum }_{{a}^{′} \neq a} {f}_{b} ( {h}^{a} ( τ ) , {h}^{{a}^{′}} ( τ ) ) d τ$$

$${y}_{n}^{a} ∼ p ( {y}_{n}^{a} \vert {h}_{n}^{a} )$$

wherein fₛ(⋅) is a first Gaussian process distribution, i.e. a Gaussian process, and fₛ(⋅) is a second Gaussian process distribution, i.e. a Gaussian process, and with a standard Gaussian distribution N(0,I) over an initial latent state h₁^{a} and assumed that the data likelihood decomposes across time and agents. The latent state hₙ^{a}(t) of an agent a at an arbitrary time t is in the example a D-dimensional vector. The latent state hₙ^{a}(t) may or may not be in the same space as a measurement y^{a}(tₙ)≡yₙ^{a}ϵ [symbol] ^{O} that is related to a physical property of the agent a. In an example,

$$p ( {y}_{n}^{a} \vert {h}_{n}^{a} ) = N ( {y}_{n}^{a} \vert B {h}_{n}^{a} , diag ( {σ}_{e}^{2} ) )$$

where Bϵ [symbol] ^{O×D} is fix B=[I, 0] with Iϵ [symbol] ^{O×O}, 0ϵ [symbol] ^{O×D-O} and maps from an interpretable latent space to an observational space, and σₑ²ϵ [symbol] ₊^{O} is a noise variance.

The model depends on an estimation of two additive functions, a kinematics function fₛ: [symbol] ^{D}→ [symbol] ^{D} and an interaction function f_{b}: [symbol] ^{2D}→ [symbol] ^{D} that are independent of each other.

The kinematics function fₛ in the example learns how an agent would move over time if there were no other agents present and is hence independent of the other agents. The interaction function f_{b} in the example learns how agents interact with each other.

The method is described for a plurality a=1, . . . , A of agents a.

The method in one example comprises determining, for each agent a, its dynamics depending on a summation consisting of A terms, i.e. one independent kinematics term that depends on the kinematics function fₛ and in the example A−1 interaction terms, each modelling an interaction of the agent a with one of the remaining A−1 agents a′ by one interaction function f_{b}. The method is not limited to determining the dynamics of each agent a. The method may comprise determining the dynamics for a subset of the plurality a=1, . . . , A of agents or a single agent a of the plurality a=1, . . . , A of agents as well. The method is not limited to determining the dynamics of an agent a depending on its interaction with the remaining A−1 agents a′. The method may comprise determining the dynamics of an agent a depending on a subset Nₐ of the plurality a=1, . . . , A of agents or depending on one agent a′ of the plurality a=1, . . . , A of agents. The subset Nₐ is in one example a neighborhood of the agent a.

The method operates in the example on a data set of P sequences Y={Yᵢ}ᵢ₌₁^{P} wherein Yᵢ=Y_{1:N}=y_{1:N}^{1:A} comprises measurements of A agents at N time points T={tₙ}ₙ₌₁^{N}.

The method comprises a step 200.

In the step 200, a data sequence y_{i:N}^{1:A} is provided.

According to the exemplary method, the agents 102 of the system 110 is observed for a fixed amount of time. In the example, the plurality a=1, . . . A of agents a represents the agents 102 and the data sequence y_{1:N}^{1:A} represents the observed quantities for the plurality a=1, . . . A of agents a within a time interval [t₁, t_{N}]. In one example, the data sequence yin comprises the agents 102 positions and velocities that are measured at certain times.

The data sequence y_{1:N}^{1:A} may be a sequence of observable states of the agents 102. The observable states may be determined depending on a measurement.

The observable states may be determined in particular from digital images, preferably video images, radar images, LiDAR images, ultrasonic images, motion images and/or thermal images of the system 110. These in the example comprise information about the position and velocity of the agents 102.

The method comprises a step 202.

In the step 202, an initial latent state h₁^{1:A} of at least one agent a at a starting time t₁ is provided.

Providing the initial latent state h₁¹ of the at least one of the agents a may comprise determining the initial latent state h₁¹ of at least one of the agents a with an encoder q_{Θ}(h₁^{1:A}y_{1:N}^{1:A}) that is configured to map the data sequence y_{1:N}^{1:A} to the initial latent state h₁^{1:A}. In the example, the initial latent state h₁^{1:A}, of the plurality a=1, . . . A of agents a is determined with the encoder q_{Θ}(h₁^{1:A}|y_{1:N}^{1:A}).

In the exemplary method, the initial values for the agents a, that are needed for ordinary differential equation integration is determined. These initial values could represent various things in general. In the example, the initial values correspond to the initial position and velocity of the respective agent a. The initial values represent in the example the initial latent state h₁^{1:A} of the system 110 at the starting time t₁.

The encoder q_{Θ} in the example is a combination of recurrent neural network and multi-layer perceptron. Another exemplary encoder would contain graph neural network layers in order to capture interactions. The encoder q_{Θ} may be another neural network architecture as well. The encoder q_{Θ} is configured to output a distribution rather than a single value.

In case the model involves the global latent variables, e.g., object-specific properties such as mass or radius, another encoder may be used to extract these variables. Both encoders may have the same architecture. Both encoders output distributions rather than single values.

The method comprises a step 204.

In the step 204, the first Gaussian process distribution GP(0,kₛ(⋅,⋅)) is provided for the first function fₛ for modelling the kinematic behavior of an agent a independently of other agents a′.

In the step 204 the second Gaussian process distribution GP(0, k_{b}(⋅,⋅)) is provided for the second function f_{b} for modelling the interaction between agents a, a′.

The kinematics function fₛ and the interaction function f_{b} is in one example unknown. The first Gaussian process distribution GP(0,kₛ(⋅,⋅)) is in one example placed on the kinematic function fₛ. The second Gaussian process distribution GP(0,k_{b}(⋅,⋅)) is in one example placed on the interaction function f_{b}. The method is not limited to the first Gaussian process distribution GP(0,kₛ(⋅,⋅)) with Zero mean and kernel kₛ(⋅,⋅). The method is not limited to the second Gaussian process distribution GP(0,k_{b}(⋅,⋅)) with Zero mean and kernel k_{b}(⋅,⋅). The method may use non-zero mean as well. The first Gaussian process distribution GP(0,kₛ(⋅,⋅)) may be approximated by a sparse Gaussian process and the second Gaussian process distribution GP(0,k_{b}(⋅,⋅)) may be approximated by a sparse Gaussian process in order to enable efficient training and predictions.

The method comprises a step 206.

In the step 206, the first function fₛ is sampled from the first Gaussian process distribution GP(0,kₛ(⋅,⋅)).

In step 206, the second function f_{b} is sampled from the second Gaussian process distribution GP(0,k_{b}(⋅,⋅)).

The first function fₛ is configured to map a latent state h^{a}(τ) of one agent a to a contribution
fₛ(h^{a}(τ))
   to a change of its latent state h^{a}(τ).

The second function f_{b} is configured to map the latent states hₐ(τ), h^{a}′(τ) of at least two agents a, a′ to a contribution
f_{b}(h^{a}(τ), h^{a}′(τ))
   to a change of a latent state h^{a}(τ) of one agent (a) of the at least two agents a, a′.

The kinematics function fₛ and the interaction function f_{b} are defined in continuous-time using ordinary differential equations. The kinematics function fₛ and the interaction function f_{b} correspond to time derivatives.

The method comprises a step 208.

In the step 208 a latent state h^{a}(tₙ) of at least one agent a at a point in time tₙ is determined.

Determining the latent state h^{a}(tₙ) of the at least one agent a at the point in time tₙ comprises changing the initial latent: state h^{1:A}(t₁) depending on a result of an integration

$${\int }_{{t}_{1}}^{{t}_{n}} {f}_{s} ( {h}^{a} ( τ ) ) + {\sum }_{{a}^{′} \neq a} {f}_{b} ( {h}^{a} ( τ ) , {h}^{{a}^{′}} ( τ ) ) d τ$$

of the change from the starting time t₁ up to the point in time tₙ. In one example, the change is determined for the plurality a=1, . . . A of agents.

The latent state h^{a}(tₙ) of one agent a that results from this change is for example determined as

$${h}^{a} ( {t}_{n} ) = {h}^{a} ( {t}_{1} ) + {\int }_{{t}_{1}}^{{t}_{n}} {f}_{s} ( {h}^{a} ( τ ) ) + {\sum }_{{a}^{′} \neq a} {f}_{b} ( {h}^{a} ( τ ) , {h}^{{a}^{′}} ( τ ) ) d τ$$

In one example, the latent state h^{a}(tₙ) is determined for the plurality a=1, . . . A of agents.

In one example, the method comprises selecting a subset Nₐ of the plurality a=1, . . . A of agents comprising an agent a and determining the change for this agent a depending on other agents a′ in the subset Nₐ. Thus, only the agents in a neighborhood of this agent a are used. The agents a′ in the subset Nₐ are selected for example depending on a measure for a distance between agents.

In one example, the method comprises changing the latent state hₐ(tₙ) of the at least one agent a at the point in time tₙ depending on at least one agent a′ that is in the subset Nₐ and independent of at least one agent of the plurality of agents a=1, . . . A that is outside of the subset Nₐ. The latent state hₐ(tₙ) of one agent a that results from this change is for example determined as

$${h}^{a} ( {t}_{n} ) = {h}^{a} ( {t}_{1} ) + {\int }_{{t}_{1}}^{{t}_{n}} {f}_{s} ( {h}^{a} ( τ ) ) + {\sum }_{{a}^{′} ∈ {N}_{a}} {f}_{b} ( {h}^{a} ( τ ) , {h}^{{a}^{′}} ( τ ) ) d τ$$

The method comprises a step 210.

In the step 210, the method comprises determining an output of the model.

$${y}^{a} ( {t}_{n} ) ∼ p ( {y}^{a} ( {t}_{n} ) \vert {h}^{a} ( {t}_{n} ) )$$

The output in the example is a trajectory sample y^{a}(tₙ) for each agent a, which in the example describes how the position and velocity of the agent 102 would change over time.

For inference, the method may end or may be repeated for determining another output e.g. for another data sequence y_{1:N}^{1:A}.

The output may be used to determine an action for at least one agent 102. A route that the agent 102 takes is, for example, determined depending on a position of other agents in order to avoid collisions. For example, the action is sending an instruction instructing the agent 102 to move to a target position. The instruction may be sent to the agent 102 or executed by the agent 102 as its action. In an example, the actions for the agents 102 are determined depending on the output.

For training, the method may comprise a step 212.

The step 212 comprises determining the first Gaussian process distribution GP(0,kₛ(⋅,⋅)) and/or the second Gaussian process distribution GP(0,k_{b}(⋅,⋅)).

In an example, during training, a sparse approximation to a posterior for the first Gaussian process distribution GP(0,kₛ(⋅,⋅)) is learnt. The first sparse Gaussian process distribution GP(0,kₛ(⋅,⋅)) has multiple variational parameters, e.g. means and variances of q(U), that are learnt iteratively in the training. This posterior is for example provided as the first Gaussian process distribution GP(0,kₛ(⋅,⋅)) in step 204.

In an example, during training, a sparse approximation to a posterior for the second Gaussian process distribution GP(0,k_{b}(⋅,⋅)) is learnt. The second sparse Gaussian process distribution GP(0,k_{b}(⋅,⋅)) has multiple variational parameters, e.g. means and variances of q(U), that are learnt iteratively in the training. This posterior is for example provided in a next iteration of the training as the second Gaussian process distribution GP(0,k_{b}(⋅,⋅)) in step 204.

The training may use as optimization goal to maximize the evidence lower bound ELBO

$$log p ( {Y}_{1 : N} ) \geq {E}_{q} [ log p ( {Y}_{1 : N} \vert {H}_{1} , f , U ) ] - K L [ q ( {H}_{1} ) \vert \vert p ( {H}_{1} ) ] - K L [ q ( U ) \vert \vert p ( U ) ]$$

wherein H₁˜q_{ϕ}(H₁|Y_{1:N}) and Φ is the parameters of a neural network encoder that outputs a Gaussian distribution with diagonal covariance, wherein p(H₁)=N(0,I) is a standard Gaussian prior with suitable dimensions for the initial latent state, wherein U^{(l)}˜q(U), f^{(l)}(⋅)˜p(f|U), wherein q(H₁) is an approximate posterior of the initial latent states, wherein l denotes a sample index, wherein q(U) is a variational posterior over its inducing points, and wherein each output dimension de [1,D] has its own independent set of inducing values U_{s,d}, U_{b,d}ϵ [symbol] ^{D} and kernel output variances σ_{s,d}², σ_{b,d}²ϵ [symbol] ₊. With f={fₛ, f_{b}}, f^{(l)}(⋅) denotes the functions fₛ,f_{b} that are drawn from the respective Gaussian process distribution for the respective sample. In this context, the conditional distribution of f(X) over the inputs X, conditioned on the inducing outputs U, is a Gaussian process

$$p ( f \vert U ) = N ( f \vert {K}_{X Z} {K}_{Z Z}^{- 1} U , {K}_{X X} - {K}_{X Z} {K}_{Z Z}^{- 1} {K}_{Z X} )$$

where K_{ZZ} is the covariance between all inducing points Z, and K_{XZ} the covariance between inducing points X and the inducing points Z. The kernels k_{b} and kₛ are functions

$$( x , {x}^{′} ) = {σ}^{2} exp ( - \frac{1}{2} {\sum }_{d = 1}^{D} \frac{{( {x}_{d} - {x}_{d}^{′} )}^{2}}{{l}_{d}^{2}} ) ,$$

where x_{d} denotes the d-th entry of the input x, σ is the respective variance and l_{d} is a dimension-wise lengthscale parameter. The use of this function k(x,x′) is optional. One could also choose a different kernel function.

The training may also comprise learning the parameters Φ of the neural network encoder and other parameters such as variance of the kernels or a noise variance.

Since this ELBO does not have a closed form expression, the trajectory samples yₙ^{a}(tₙ) are used for an approximation with an expected likelihood term

$${E}_{q} [ log p ( {Y}_{1 : N} \vert \cdot ) ] \approx \frac{1}{L} {\sum }_{l , n , a} log N ( {y}_{n}^{a} \vert B {h}_{n}^{a ( l )} , {σ}_{e}^{2} )$$

where the log-likelihood term decomposes between agents and between time points, enabling doubly stochastic variational inference.

The terms KL[⋅] correspond to a Kullback-Leibler regularizer. The prior distribution over the inducing variables follow the Gaussian process p(U)=p(Uₛ)p(U_{b}) with p(Uₛ)=N(f|μ_{U}_{ₛ}, K_{U}_{ₛ}_{U}_{ₛ}) and p(U_{b})=N(f|μ_{U}_{_{b}}, K_{U}_{_{b}}_{U}_{_{b}}). The Kullback-Leibler regularizer is determined in the example in closed form.

In one example, the model comprises second-order ordinary differential equations:

$${h}^{a} ( t ) ≡ [ {s}^{a} ( t ) , {v}^{a} ( t ) ]$$

$$\frac{d}{d t} {h}^{a} ( t ) = [ {v}^{a} ( t ) , \frac{d}{d t} {v}^{a} ( t ) ]$$

$$\frac{d}{d t} {v}^{a} ( t ) = {f}_{s} ( {h}^{a} ( t ) ) + {\sum }_{a \neq {a}^{′}} {f}_{b} ( {h}^{a} ( t ) , {h}^{{a}^{′}} ( t ) )$$

This means, the latent state h^{a}(t) of the agent a comprises a first component s^{a}(t) and a second component v^{a}(t). The method comprises changing the latent state h^{a}(t) of the agent a depending on the second component v^{a}(t) of the latent state of the agent a and a change

$$\frac{d}{dt} {v}^{a} ( t )$$

to the second component v^{a}(t) of the latent state of the agent a. The second component v^{a}(t) is changed depending on the contribution fₛ(h^{a}(t)) to the change of the latent state of the agent a and the contribution f_{b}(h^{a}(t), h^{a}′(t)) to the change of the latent state of the agent a.

This alleviates inference since it removes otherwise non-identifiable issues and allows an enhanced interpretation of the latent states s^{a}(t), v^{a}(t). In the example, s^{a}(t) is a latent state corresponding to a position and v^{a}(t) is a latent state corresponding to a velocity of an agent. The implementation of the method is accordingly.

Second-order ordinary differential equations produce a significantly better performance than first-order ordinary differential equations when there is missing data.

1-15. (canceled)

16. A computer-implemented method for continuous-time interaction modeling of agents, the method comprising the following steps:
providing a latent state of a first agent and a latent state of a second agent, in characterizing a position or a velocity of the first and second agents, respectively;
providing a first Gaussian process distribution for a first function for modelling a kinematic behavior of an agent independently of other agents and a second Gaussian process distribution for a second function for modelling an interaction between agents;
sampling the first function from the first Gaussian process distribution and the second function from the second Gaussian process distribution, wherein the first function is configured to map a latent state of one agent to a contribution to a change of its latent state, wherein the second function is configured to map the latent states of two agents to a contribution to a change of a latent state of one of the two agents; and
changing the latent state of the first agent depending on a first contribution that results from mapping of the latent state of the first agent with the first function to the first contribution, and a second contribution that results from mapping the latent state of the first agent and the latent state of the second agent with the second function to the second contribution.

17. The method according to claim 16, further comprising:
providing an initial latent state of a plurality of agents including the first agent and the second agent, and:
(i) changing the latent state of the first agent depending on second contributions that result from mapping pairs of the latent state of the first agent and different second agents of the plurality of agents with the second function, or
(ii) selecting a subset of the plurality of agents, and changing the latent state of the first agent depending on second contributions that result from mapping pairs of the latent state of the first agent and different second agents of the subset with the second function.

18. The method according to claim 17, further comprising:
determining agents from the plurality of agents for the subset that are, according to a measure for a distance between agents, closer to the first agent than other agents of the plurality of agents.

19. The method according to claim 16, further comprising:
providing a data sequence, and providing an initial latent state of the first agent and/or the second agent including determining its initial latent state with an encoder that is configured to map the data sequence to its initial latent state.

20. The method according to claim 16, further comprising:
determining an output depending on the latent state of the first agent, including a trajectory of a position and/or velocity of the first agent over time.

21. The method according claim 20, wherein:
the first Gaussian process distribution includes a posterior, and wherein the method includes learning a sparse approximation to the posterior for the first Gaussian process distribution that entails variational parameters, and providing the approximation for the first Gaussian process distribution as the first Gaussian process distribution, and/or
the second Gaussian process distribution includes a posterior, and wherein the method includes learning a sparse approximation to the posterior for the second Gaussian process distribution that entails variational parameters, and providing the approximation for the second Gaussian process distribution as the second Gaussian process distribution.

22. The method according to claim 21, further comprising:
determining the first Gaussian process distribution or the second Gaussian process distribution with an expected likelihood term that depends on the output and that decomposes between agents and between time points.

23. The method according to claim 16, wherein the latent state of the first agent includes a first component and a second component, and wherein the method comprises changing the latent state of the first component of the latent state of the first agent depending on the second component of the latent state of the first agent and a change to the second component of the latent state of the first agent, wherein the second component of the latent state of the first agent is changed depending on the first contribution to the change of the latent state of the first agent and the second contribution to the change of the latent state of the first agent.

24. The method according to claim 20, further comprising:
determining an action for the first agent depending on the output.

25. The method according to claim 16, further comprising determining the latent state of the first agent and the latent state of the second agent depending on a measurement of an sequence of observable states of the agents.

26. The method according to claim 25, wherein:
(i) the first agent is an existing object in the physical world, wherein the latent state of the first agent is determined depending on a measurement of a property of the first agent, and/or
(ii) the second agent is an existing object in the physical world, wherein the latent state of the second agent is determined depending on a measurement of a property of the second agent;
wherein the measurement includes position data from a satellite navigation system, and/or digital images, and/or video images, and/or radar images, and/or LiDAR images, and/or ultrasonic images, and/or motion images and/or thermal images, from information about a position or a velocity of the agents.

27. A device for continuous-time interaction modeling of agents, comprising:
at least one processor; and
at least one memory;
wherein the device is configured to:
provide a latent state of a first agent and a latent state of a second agent, in characterizing a position or a velocity of the first and second agents, respectively,
provide a first Gaussian process distribution for a first function for modelling a kinematic behavior of an agent independently of other agents and a second Gaussian process distribution for a second function for modelling an interaction between agents,
sample the first function from the first Gaussian process distribution and the second function from the second Gaussian process distribution, wherein the first function is configured to map a latent state of one agent to a contribution to a change of its latent state, wherein the second function is configured to map the latent states of two agents to a contribution to a change of a latent state of one of the two agents, and
change the latent state of the first agent depending on a first contribution that results from mapping of the latent state of the first agent with the first function to the first contribution, and a second contribution that results from mapping the latent state of the first agent and the latent state of the second agent with the second function to the second contribution.

28. The device according to claim 27, wherein the device further comprises:
an interface that is adapted to observe the continuous-time interaction of the agents including capturing a measurement of an sequence of observable states, including digital images and/or video images and/or radar images and/or LiDAR images and/or ultrasonic images and/or motion images and/or thermal images, and/or or to receive information about the continuous-time interaction of the agents.

29. The device according to claim 28, wherein the device is configured to determine an output depending on the latent state of the first agent, including a trajectory of a position and/or velocity of the first agent over time, and wherein the interface is adapted to control an action of at least one of the agents depending on the output.

30. A non-transitory computer-readable medium on which is stored a computer program including computer readable instructions for continuous-time interaction modeling of agents, the instructions, when executed by a computer, causing the computer to perform the following steps:
providing a latent state of a first agent and a latent state of a second agent, in characterizing a position or a velocity of the first and second agents, respectively;
providing a first Gaussian process distribution for a first function for modelling a kinematic behavior of an agent independently of other agents and a second Gaussian process distribution for a second function for modelling an interaction between agents;
sampling the first function from the first Gaussian process distribution and the second function from the second Gaussian process distribution, wherein the first function is configured to map a latent state of one agent to a contribution to a change of its latent state, wherein the second function is configured to map the latent states of two agents to a contribution to a change of a latent state of one of the two agents; and
changing the latent state of the first agent depending on a first contribution that results from mapping of the latent state of the first agent with the first function to the first contribution, and a second contribution that results from mapping the latent state of the first agent and the latent state of the second agent with the second function to the second contribution.
